(19) United States
(12) Patent Application Publication
(10) Pub. No.: US 2024/0369493 A1
(43) Pub. Date: Nov. 7, 2024

(54) System and Method for Qualitative and Quantitative Detection of Substance on Surfaces

(71) Applicant: Kirollos Salama Kirollos, Virgina Beach, VA (US)

(72) Inventor: Kirollos Salama Kirollos, Virgina Beach, VA (US)

(21) Appl. No.: 18/668,043

(22) Filed: May 17, 2024

Related U.S. Application Data
(63) Continuation-in-part of application No. 16/397,404, filed on Apr. 29, 2019, now abandoned.

(51) Int. Cl. G01N 21/78

(52) U.S. Cl. CPC G01N 21/78

(57) ABSTRACT

A surface wipe for the detection of harmful substances on surfaces by producing uniform color change and a color comparator to determine the concentration of harmful substance collected on the wipe by comparing the intensity and hue of the uniform color on the wipe to a calibrated color scale related to specific concentration of the target harmful substance. In operation, the wipe is held from the handle to swipe a suspect surface. The pressure applied by fingers at certain areas on the rigid or flexible top support member of the wipe during the swiping process is transferred to the flexible wipe body. The flexible body of the wipe uniformly distribute the pressure applied by fingers throughout its mass and/or take the shape of irregular and uneven surface allowing the collection and color forming assembly to produce uniform color change that can be quantified by the color comparator.

### CROSS-REFERENCE TO RELATED APPLICATION

The present invention is a Continuation-in-Part Application of U.S. patent Ser. No. 16/397,404 and relates to U.S. Provisional Patent Ser. No. 62/666,135 filed on May 3, 2018 and claims priority therefrom.

### STATEMENT REGARDING FEDERAL SPONSORED RESEARCH OR DEVELOPMENT

The patent application did not receive federal research and development funds.

### FIELD OF THE INVENTION

The present invention relates generally to a direct-read device, method and apparatus for protecting against exposure to harmful environments. In this regard, the present invention relates generally to the indication of substance by changing color. The surface wipe and color comparator (SW & CC) of the present invention function by swiping surfaces for target substance, if the wiped surface is contaminated with target substance, a uniform color change appears on the wipe. The intensity of the produced uniform color change is directly proportional to the amount of target substance collected on the wipe. To determine the amount of the collected substance, the uniform color on the wipe is compared to a pre-calibrated color scale on the color comparator. When a specific area of surface, i.e. square foot (ft²) or 10 centimeters' square (10cm²) is wiped, the concentration of substance can be determined; for example, in micrograms/ft² or micrograms/10cm². The color comparator of the present invention includes an arbitrary grayscale to compensate for any dark substance or dirt collected on the wipe.

### BACKGROUND OF THE INVENTION

The need for simple, low cost and real-time qualitative and quantitative detection of trace amounts of toxic substances on surfaces is of great importance to health in the workplace and the environment. Although the current Occupational Safety and Health Administration (OSHA) standards have no surface contamination criteria or quantifications for surface contamination, the standards generally contain housekeeping provisions that address the issue of surface contamination. Exposures to various chemicals are addressed in specific standards for general industry, construction, and shipyard employment. OSHA housekeeping provisions are generally the most stringent for the metals, which in solid form may contaminate surfaces and become available for ingestion or inhalation if housekeeping practices are poor. OSHA standards for heavy metals contain provisions stating that “surfaces be maintained as free as practicable of accumulations of the toxic metal” [Code of Federal Regulations (CFR) for Occupational Safety and Health Standards 29 CFR 1910]. Useful guidelines are also provided by the U.S. Department of Energy (DOE), where DOE and its contractors are required to conduct routine surface sampling to determine housekeeping conditions wherever highly toxic and carcinogenic substances such as beryllium and hexavalent chromium [Cr (VI)] are present in operational areas. These criteria, for example, state that for beryllium, the removable contamination level of equipment or item surfaces does not exceed the higher of 0.2 μg/100 cm² and for Cr (VI), an acceptable surface contamination level of 7.5 μg/100cm².

There are numerous devices and methods for collecting and stabilizing the collected samples from surfaces for further laboratory analysis. Avery et al., U.S. Pat. No. 3,450,129 (Jun. 17, 1969) teaches a self-swabbing unit for collection of cultures from body canals and a crushable glass ampoule filled with liquid to stabilize the collected cultures for further laboratory analysis. Several variations of Avery device are described in the literature, including U.S. Pat. Nos. 3,792,699, 3,890,204, 3,890,954, 3,913,564, 4, 184,483, 4,311,792, 4,604,360 and 4,770,853. Addleman et al., U.S. Pat. No. 8,943,910 (Feb. 3, 2015) teaches an enhanced swipe sampler with functionalized fibers for collecting explosives and other substances from surfaces.

There are also several devices and methods for direct-read, real-time qualitative (yes/no) detection of toxic substances on surface. Stone, U.S. Pat. No. 5,039,618 (Aug. 13, 1991), U.S. Pat. No. 5,278,075 (Jan. 11, 1994) and U.S. Pat. No. 5,330,917 (Jul. 19, 1994) teaches swabs having a hollow stem and within the hollow stem is one or two cartridges. Crushing the cartridges before swiping surface, a color form if target substance found on surface. Another teaching of Stone, U.S. Pat. No. 5,364,792 (Nov. 15, 1994) where a swab having a hollow stem and within the hollow stem is a cartridge within another cartridge, an activator solution is in one of the cartridges and a reagent is in another of the cartridges. Crushing the cartridges before swiping surface, a color form if target substance found on surface. In all Stone devices, an absorbent ball at the end of the hollow stem is soaked with reagents prior to swiping the target surface. A color formed on the soaked ball to indicate qualitative indication of target contaminants. Kirollos et al. U.S. patent application Ser. No. 20/060,062689 (Mar. 23, 2006), describes a surface wipe for real-time qualitative detection of toxic substances where a collection media filters dirt to prevent or reduce inaccurate readings and the color change may be viewed through a clear backing. In an effort to quantify the collected substance, a grid work is printed on the clear backing of the wipe, the more cells of the grid that changed in color indicate a more heavily contaminated surface area. Although this device provides a general idea about the quantity of collected substance, the irregularity of the color formed in this device makes it impossible to accurately determine the quantity of the collected substance. The irregularity of the produced color is due to different pressure applied to the surface. The most intense color produced on the wipe is under the fingers of the person swiping the surface, where most of the pressure applied. The use of the applicator with the wipe can only produce relatively uniform color if the swiped surface is flat and smooth. Pagoria, et al., U.S. Pat. No. 7,829,020 (Nov. 9, 2010) teaches a colorimetric device for the detection of peroxides where a swipe material attached to a polyethylene tube contains two crushable vials with reagents. After swiping a suspected surface, the vials are broken. Peroxides are confirmed by a deep blue color. Genovese, et al., U.S. Pat. No. 9,023,291 (May 5, 2015) teaches colorimetric detection kit comprising a unit containing chemical reagents and a sample collector for collecting a sample analyte from a surface and a separate unit for visualizing a possible reaction of the chemical reagent and sample. Johnson U.S. Pat. No. 9,250,189 (Feb. 2, 2016) teaches a detection kit used for detecting compounds and includes a magnifying lens in a cap that magnifies a surface of a color-changing detection swab when placed on the body of the detection kit.

All the above-mentioned devices and method are intended for; either the collection of substances from surfaces for further laboratory analysis to determine the nature (qualitative) and concentration (quantitative) of target substances on surfaces, or direct-read, colorimetric surface wipes for qualitative (yes/no) detection of substance on surfaces. To our knowledge, there is no direct-read real-time device for qualitative and quantitative determination of substances on surfaces.

There are several color comparators in the literature for testing liquids by comparing the color of the liquid with graduated color standards. Frank, U.S. Pat. No. 3,964,831 (Jun. 22, 1976), teaches a visual color comparator for testing the condition of a liquid and utilizing dual liquid dip cells which are integrally connected. Aronowitz, et al., U.S. Pat. No. 4,877,580 (Oct. 31, 1989) teaches an assay kit comprising an analyte test strip and a color comparator including a plurality of different color fields arranged in an ordered, preferably linear, succession. There is an aperture through each color field so positioned that the reaction zone of the test strip can be placed behind each color field and the color of the reaction zone thereafter viewed through each aperture. Kuzuhara, et al., U.S. Pat. No. 5,972,713 (Oct. 26, 1999) teaches a method for determining total chlorine amount present in a sample and a kit for practicing the method includes the indicator and a color scale for the hues of the dye. There are other color comparators sited in the literature including the following US Patents are depicted herein for reference; Peet, U.S. Pat. No. 1,976,672 (October 1934), Frank, U.S. Pat. No. 3,176,577 (April 1965), Rosse et al., U.S. Pat. No. 3,718,439 (February 1973) and Acker et al., U.S. Pat. No. 3,837,745 (September 1974).

### BRIEF SUMMARY OF THE INVENTION

It is a general objective of the present invention to provide a reliable and cost-effective device and method for the detection of substances on surfaces.

A primary objective of the present invention is to provide a direct-read device and a method capable of real-time qualitative and quantitative detection of substances on surfaces.

Another object of the present invention is to provide a device capable of the indication of substances by changing color.

Yet another objective of the present invention is to provide a simple means of detecting trace amounts of toxic substances existing on irregular and/or rough surfaces and producing uniform color for quantification.

Another objective of the present invention is to provide a simple means of detecting trace amounts of toxic substances existing on surfaces covered with dirt, soil and/or dark substances.

### BRIEF DESCRIPTION OF THE DRAWINGS

FIG. 1 is a schematic drawing of one embodiment of the surface wipe (100) and the color comparator (200) of the present invention.

FIG. 2A is a schematic drawing of the surface wipe (100) of the present invention.

FIG. 2B is a cross section of one embodiment of the surface wipe (100).

FIG. 3A is a cross section of another embodiment of the surface wipe (100) where a crushable ampoule is located inside the wipe's body.

FIG. 3B depicts a cross section view perpendicular to the cross section shown in FIG. 3A.

FIG. 4 is an exploded view of one embodiment of the surface wipe (100) of the present invention.

FIG. 5 is a schematic drawing of the surface wipe (100) in use for wiping smooth surface.

FIG. 6 is a schematic drawing of the surface wipe (100) in use for wiping irregular and rough surface.

FIG. 7 is an exploded view of one embodiment of the color comparator (200) of the present invention where the top wheel is first gray scale wheel (220) and the bottom wheel is first color wheel (240).

FIG. 8 is an exploded view of another embodiment of the color comparator (200) of the present invention where the top wheel is second color wheel (242) and the bottom wheel is first color wheel (240).

FIG. 9 is a top view of one embodiment of the color comparator (200) showing more detail of the first numbers window (213) and showing the alphabets (227) on the first gray scale wheel (220) and the numerals (247) on the first color wheel (240).

FIG. 10 is a schematic drawing of the surface wipe (100) and one embodiment of the color comparator (200) in use to determine the amount of substance collected on the surface wipe.

FIG. 11 is an exploded view of yet another embodiment of the color comparator (200).

FIG. 12 is a top view showing the overlap of the first color wheel (240) and the third color wheel (245) of one embodiment of the color comparator (200).

FIG. 13A is a schematic drawing of one embodiment of the first color wheel (240).

FIG. 13B is a schematic drawing of one embodiment of the arbitrary first gray scale wheel (220).

FIG. 14B is schematic drawing of one embodiment of the surface wipe (100) where the handle (130) is attached to the top support (120) with two clear one sided adhesive circles (131) and (132).

FIG. 14B is the side view of FIG. 14A.

FIG. 15A is one embodiment of the surface wipe (100) where the top support (120) and the wiping and color forming member (140) are attached to the wipe body (110) with clear double-sided adhesive (121) and (150).

FIG. 15B is one embodiment of the surface wipe (100) where the top support (120) is attached to the wipe body (110) with liquid adhesive (122).

FIG. 16A is one embodiment of the surface wipe (100) where the wiping and color forming member (140) is attached to the wipe body (110) with liquid adhesive (153).

FIG. 16B is one embodiment of the surface wipe (100) where the top support (120) and the wiping and color forming member (140) are attached to the wipe body (110) with liquid adhesive (122) and (153).

FIG. 17A is schematic drawing of the surface wipe (100) in use where the wipe body (112) is constructed from low density foam.

FIG. 17B is schematic drawing of the surface wipe (100) in use where the wipe body (113) is constructed from high density foam.

FIG. 18A is an exploded view of the color wheel (253) where two coaxial color wheels (248) and (249) attached to each other with liquid adhesive (244).

FIG. 18B is schematic view of the color wheel (253).

FIG. 19A is side view of the first magnifying lens (216) on top of the first numbers window (213) and attached to the top comparator bod (210) with liquid adhesive (218).

FIG. 19B is side view of the first magnifying lens (216) on top of the first numbers window (213) and attached to the top comparator body (222) having perforation around the edge of the first numbers window (213) with liquid adhesive (219).

FIG. 20 is schematic of the first separator (260) attached to the bottom color body (250) with double sided adhesive (262).

### LIST OF NUMERALS

100 is surface wipe assembly.
110 is wipe body.
111 is wipe body cavity.
120 is top support.
130 is handle.
140 is the wiping and color forming assembly.
141 is color forming member.
142 is wiping member.
150 is bottom support.
151 is bottom support opening.
160 is crushable ampule.
200 is color comparator assembly.
210 is top comparator body.
211 is rivet first top opening.
212 is rivet second top opening.
213 is first numbers window.
214 is second numbers window.
215 is color scale window.
216 is first magnifying lens.
217 is second magnifying lens.
220 is first gray scale wheel.
221 is first gray scale wheel rivet opening.
225 is the second gray scale wheel.
226 is the second gray scale wheel rivet opening.
227 are alphabets on the first gray scale wheel (220)
230 is comparator insert.
231 is the right comparator insert member.
232 is left comparator insert member.
240 is the first color wheel.
241 is the first color wheel rivet opening.
242 is the second color wheel.
243 is the second color wheel rivet opening.
245 is the third color wheel.
246 is third color wheel rivet opening.
247 are the numerals on the first color wheel (240)
250 is bottom color comparator body.
251 is rivet first bottom opening.
252 is rivet second bottom opening.
260 is the first separator.
261 is the second separator.
270 is first rivet.
271 is the second rivet.
280 is protective sleeve.
300 is irregular surface.
131 is the first clear one-sided adhesive circle.
132 is the second clear one-sided adhesive circle.
122 is liquid adhesive attaching the top support 120 to wipe body 110.
153 is liquid adhesive attaching the wiping and color forming assembly.
140 to wipe body 110.
112 is low density wipe body.
113 is high density wipe body.
253 is the fourth color wheel.
248 is the top component of the fourth color wheel 253.
249 is the bottom component of the fourth color wheel 253.
244 is the liquid adhesive holding together the top component of the fourth color wheel 253 and the bottom component of the fourth color wheel 253.
218 is liquid adhesive holding the magnifying lens 216 to the top comparator body 210.
219 is liquid adhesive forming anchor shape holding the magnifying lens
216 to the top comparator body 222.
222 is top comparator body perforated around the edge of the first numbers window 213.
262 is double sided adhesive holding the first separator 260 to the bottom color comparator body 250.

### Detailed Description of the Invention

The present invention is a surface wipe, generally indicated as (100) in figures, for the detection of harmful substances on surfaces by producing uniform color change, and a color comparator to determine the concentration of harmful substance collected on the surface wipe (100) by comparing the intensity and hue of the uniform color on the surface wipe to a calibrated color scale related to specific quantities and/or concentrations of the target harmful substance, the color comparator is generally indicated as (200) in figures, as will be described more fully herein below.

In operation, the surface wipe (100) is held from the handle (130), preferably, using the thumb and index fingers to swipe a suspect surface contaminated by harmful substance. The pressure applied by thumb and index fingers at certain areas on the rigid or flexible top support member (120) during the swiping process is transferred to the flexible body (110). The flexible body of the surface wipe (110) uniformly distribute the pressure applied by fingers throughout its mass and/or take the shape of irregular and uneven surface allowing the collection and color forming assembly (140) to produce uniform color change that can easily and accurately be quantified by the color comparator (200).

The handle (130) is constructed from clear or opaque flexible polyester, polypropylene, polyethylene, or any plastic satisfies its intended function of holding the surface wipe (100), preferably, using the thumb and index fingers. The handle (130) is attached or glued to the top support (120).

The top support (120) is constructed from clear or opaque rigid or flexible polyester, polypropylene, polyethylene, or any plastic satisfies its intended function of holding the handle (130) to the surface wipe body (110). The top support (120) is attached to the surface wipe body (110) with adhesive or double-sided adhesive tape. The adhesive and the adhesive tape are preferably constructed from silicon, but it can be acrylic or any kind of adhesive that doesn't off-gas any substance that may damage the active ingredient(s) of the collection and color forming assembly (140).

The surface wipe body (110) is constructed from closed or open pores, flexible foam or rubber and functions as a cushion to spread the pressure applied by fingers during the swiping process through its mass. In one embodiment, where the top support (120) is rigid plastic, the pressure applied by fingers during the swiping process is spread uniformly through the surface wipe body (110). In another embodiment, where the top support (120) is flexible plastic, the pressure applied by fingers at certain areas, during the swiping process, causes the top support (120) and the surface wipe body (110) to bend and take the shape of fingers tips, while the surface wipe body (110) functions as a cushion spreading the pressure applied by the fingers throughout its mass. The flexibility of the surface wipe body (110) also functions to take the shape of irregular and rough surfaces allowing the collection and color forming assembly (140) to uniformly swipe the target irregular and rough surfaces. In yet another embodiment, the surface wipe body (110) has a cavity (111) for placing a crushable ampoule (160). The crushable ampoule (160) may contains liquid, such as water or alcohol. In this embodiment, the ampoule is crushed before swiping the surface to wet the collection and color forming assembly (140) to maximize the collection of target substance from the surface. In another embodiment, the crushable ampoule (160) contains a reagent, or reagents needed to react with the color forming member (141) before swiping the target surface to allow color formation in case target substance found on surface. In yet another embodiment, the crushable ampoule (160) contains a reagent, or reagents needed to react with the color forming member (141) and the target substance after the swing process when the target substance already collected on the collection member (142).

The bottom support (150) is constructed from clear or opaque flexible polyester, polypropylene, polyethylene or any plastic satisfies its intended function of attaching the collection and color forming assembly (140) to the surface wipe body (110). In one embodiment, the bottom support (150) has adhesive or double-sided adhesive tape from both sides to attach the surface wipe body (110) to the collection and color forming assembly (140). The adhesive and double-sided adhesive tape are preferably constructed from silicon, but it can be acrylic or any kind of adhesive that does not off-gas any substance that may damage the active ingredient(s) of the collection and color forming assembly (140). In another embodiment, the bottom support (150) has an opening or perforation (151) to allow the reagent(s) from the crushed ampoule (160) to pass to the collection and color forming assembly (140).

In one embodiment, the collection and color forming assembly (140) is constructed from inert felt, fiber glass or open pores, flexible plastic such as polypropylene and or polyethylene impregnated with reagent or reagents capable of forming color when reacting with target substance. In other embodiment, the impregnated reagents in the collection and color forming assembly (140) are activated by an activating reagent from the crushable ampoule (160) before swiping the target surface. In yet another embodiment, after swiping the target surface, the crushable ampoule (160) is crushed, and the released reagent(s) react with the impregnated reagent or reagents in the collection and color forming assembly (140) and the collected target substance to form uniform color change.

In other embodiment of the collection and color forming assembly (140), the collection member (142) is constructed from inert felt, fiber glass or open pores, flexible plastic such as polypropylene and or polyethylene. The color forming member (141) is coated on top of the collection member (142), the side facing the bottom support member (150). The color forming member (141) is constructed from colorimetric reagent(s), porous support(s) and inert binder(s) forming uniform emulsion coated uniformly on top of the collection member (142), the side facing the bottom support member (150).

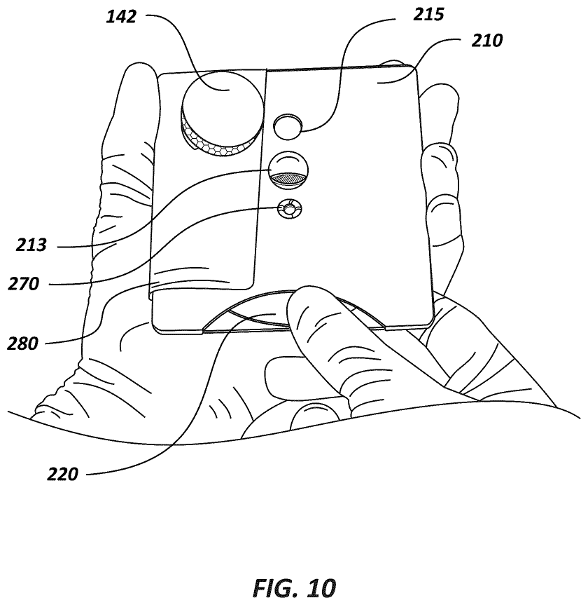

In one embodiment of the current invention in use, the swiped surface wipe (100) is placed upside-down next to the color scale window (215) on the color comparator (200) as shown in FIG. 10. The first color wheel (240) is then turned until a color matches on the wipe (100) and specific color on the first color wheel (240) appears through the color scale window (215) is achieved. The number appears on the first number window (213) corresponds to specific amount or concentration of the target substance collected on the wipe (100). The amount of target substance can be expressed in milligrams (mg) or micrograms (μg). When a certain area, i.e. 1 ft² or 10cm², of the suspect surface is swiped, the number appears on the first number window (213) corresponds to specific concentration of the target substance collected on the wipe (100) expressed in mg/ft² or μg/cm².

In one embodiment, the color comparator (200) of the present invention is constructed from first color wheel (240) located under, and coaxial with, first gray scale wheel (220). The coaxial first color wheel (240) and the first gray scale wheel (220) are sandwiched between, and coaxial with, top comparator body (210) and bottom comparator body (250). The top comparator body (210) and bottom comparator body (250) are separated by the comparator insert (230) to allow free rotation and turning of the coaxial first color wheel (240) and the first gray scale wheel (220). The coaxial first color wheel (240) and the first gray scale wheel (220) are separated by the first separator (260) having smooth surface from both sides. In use the first separator (260) allows finger, preferably thumb, to smoothly turn the top first gray scale wheel (220) while other finger, preferably index finger, to hold the bottom first color wheel (240) in place. The first separator also allows finger, preferably thumb, to hold top first gray wheel (220) in place while another finger, preferably index, to easily turn bottom first color wheel (240). The axis of the coaxial (210), (220), (240) and (250) can be a screw and nut or rivet (270).

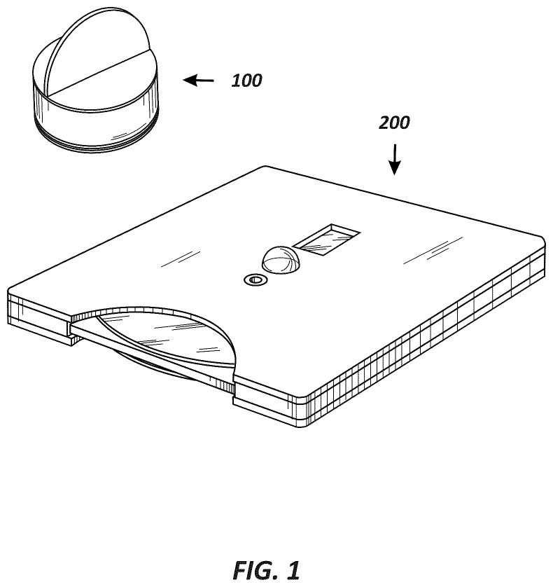

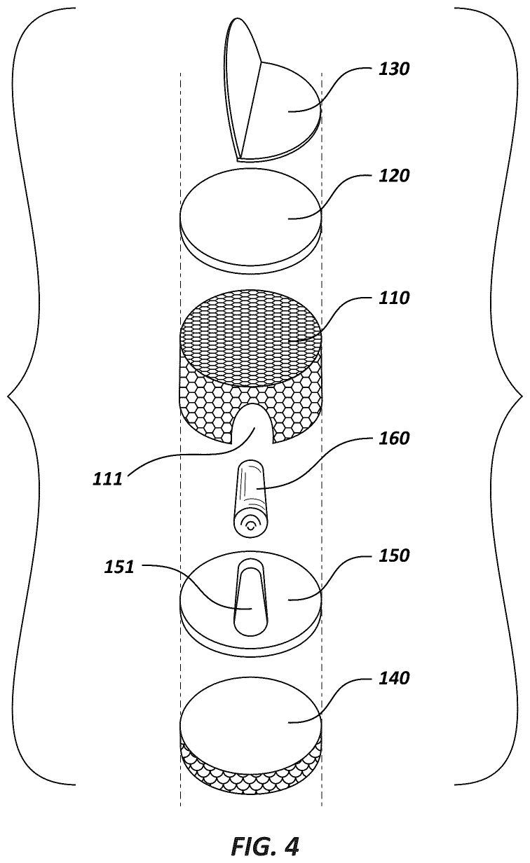

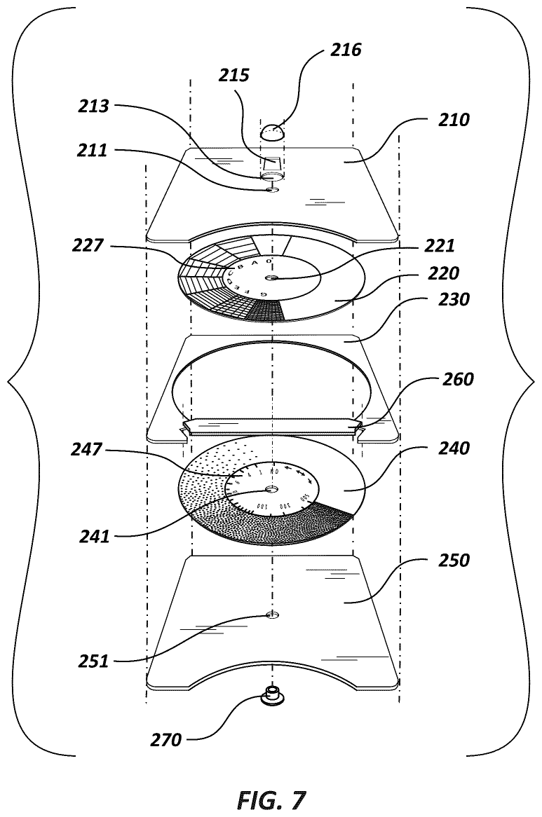

FIG. 1 depicts a general view of one embodiment of the surface wipe (100) and the color comparator (200) of the present invention. FIG. 4 shows an exploded view of one embodiment of the surface wipe (100) depicted in FIG. 1, and FIG. 7 shows an exploded view of the embodiment of the color comparator (200) depicted in FIG. 1 and will be described in detail herein below.

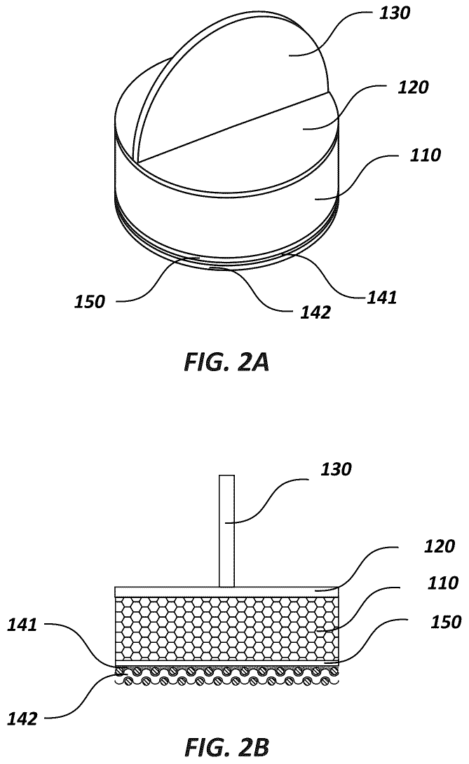

FIG. 2A is a more detailed illustration of one embodiment of the surface wipe (100) showing the handle (130), the top support (120), the wipe body (110), the bottom support (150), a color forming member (141) and a collection member (142).

FIG. 2B is a cross section of the surface wipe (100) depicted in FIG. 2A, where the color forming member (141) is coated on top of the collection member (142).

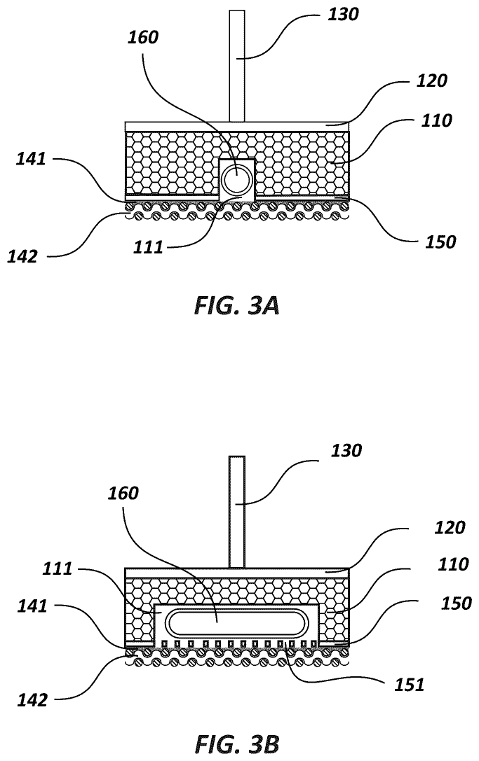

FIG. 3A is another cross section of the surface wipe (100) where the surface wipe body (110) has a cavity (111) to accommodate a crushable ampoule (160) and the bottom support has an opening or perforation (151) to allow the reagent(s) from the crushed ampoule (160) to pass to the collection and color forming assembly (140).

FIG. 3B depicts a cross section view perpendicular to the cross section shown in FIG. 3A.

FIG. 4 is an exploded view of one embodiment of the surface wipe (100). In this embodiment, the handle (130) is a round plastic bent in the middle at right angle and glued to the top support (120). The handle (130) has a diameter 0.75 to 2.0 inch, preferably 1.25 inch and thickness of 2 thousandths of an inch (2 mils) to 50 mils, preferably 7 mils. The top support (120) is a flexible or rigid plastic having diameter of 0.75 to 2.0 inch, preferably 1.25 inch and a thickness of 25 to 100 mils, preferably 50 mils. The surface wipe body (110) is flexible plastic or rubber having a diameter similar to the top support (120) and a thickness of 0.3 to 0.7 inch, preferably 0.35 inch. In this embodiment, the surface wipe body (110) has a cavity (111) to accommodate the crushable ampoule (160). The bottom support (150) is a flexible plastic or rubber having a diameter similar to the top support (120) and thickness of 25 to 100 mils, preferably 50 mils. In this embodiment, the bottom support (150) has an opening or perforation (151) to allow the reagent(s) from the crushed ampoule (160) to pass to the collection and color forming assembly (140). The collection and color forming assembly (140) is constructed from inert felt, fiber glass or open pores, flexible plastic impregnated with reagent or reagents capable of forming color when reacting with target substance. The collection and color forming assembly (140) have a diameter similar to the bottom support (150) and thickness of 5 to 20 mils, preferably 10 mils.

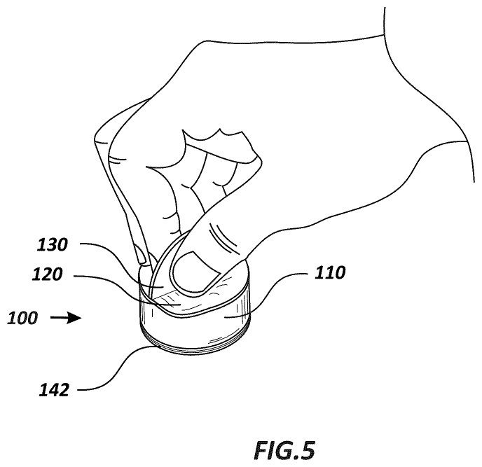

FIG. 5 showing the surface wipe (100) in use swiping a smooth surface. In a preferred embodiment, the handle (130) is held using thumb and index fingers.

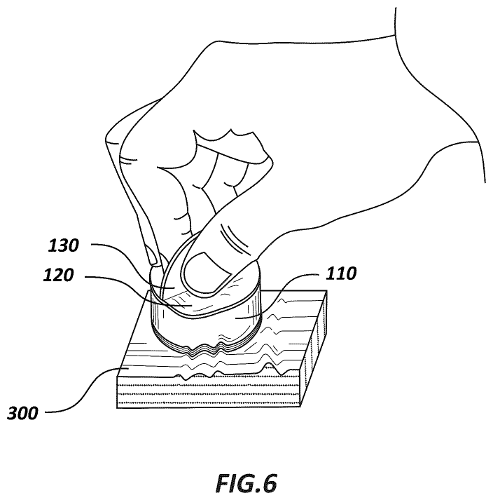

FIG. 6 showing the surface wipe (100) in use swiping irregular and rough surface. In a preferred embodiment, the handle (130) is held using thumb and. index fingers. The pressure applied by fingers at certain areas, during the swiping process, causes the top support (120) and the surface wipe body (110) to bend and take the shape of fingers tips, while the surface wipe body (110) functions as a cushion spreading the pressure applied by the fingers throughout its mass. The flexibility of the surface wipe body (110) also functions to take the shape of irregular and rough surfaces allowing the collection and color forming assembly (140) to uniformly swipe the target irregular and rough surfaces.

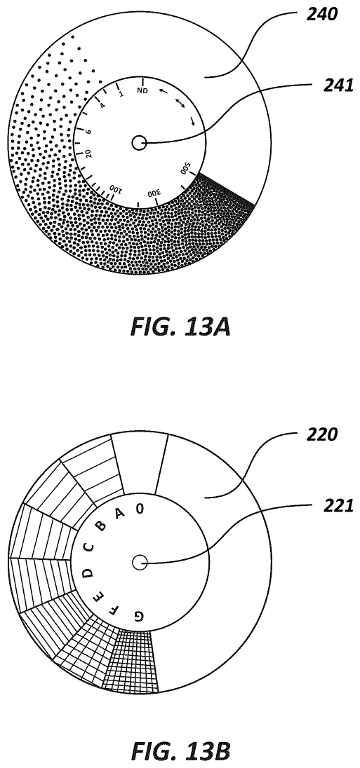

FIG. 7 is an exploded view of one embodiment of the color comparator (200) depicted in FIG. 1. The top comparator body (210) is constructed from plastic, preferably polypropylene or polyethylene and it can also be constructed from cardboard. The top comparator body (210) has a length between 3.5 and 5.0 inches, preferably 4.0 inches, width between 3.5 and 5.0 inches, preferably 4.0 inches and thickness of 10.0 and 25.0 mils, preferably 15.0 mils. The top comparator body (210) has color scale window (215) aligned on top of the gray scale of the first gray scale wheel (220) and the color scale of the first color wheel (240). The top comparator body (210) also has the first numbers window (213) aligned on top of the alphabets or the numbers (227) on the first gray scale wheel (220) and the numbers (247) on the first color wheel (240). A first magnifying lens (216) is attached on top of the first numbers window (213) to magnify the alphabets (227) and numbers (247) appear on the first numbers window (213) from the first gray scale wheel (220) and the first color wheel (240) to enhance the visual appearance of the alphabets and numbers. The top comparator body (210) has a third opening, the rivet first top opening (211), coaxial with the first gray scale wheel rivet opening (221), the first color wheel rivet opening (241) and the rivet's first bottom opening (251). The first gray scale wheel (220) is constructed from transparent plastic such as polyester or polystyrene having a diameter between 3 inches and 5 inches, preferably 3.6 inches and thickness between 5 mils and 15 mils, preferably 10 mils. The first gray scale wheel (220) has an arbitrary gray scale to enhance the color matching process and has no effect in determining the quantity or concentration of the collected target substance on the surface wipe (100). The gray scale can be step increments of gray color as shown in FIG. 13B or gradual smooth increments. The gray scale can be gray color or brown color to match the color of soil or dirt. The first gray scale wheel (220) has an opening in the middle, the first gray scale wheel rivet opening (221), coaxial with and under the rivet first opening (211) and on top of the first color wheel rivet opening (241). The comparator's insert (230) function to separate the top comparator body (210) from the bottom comparator body (250) and allow free movement and turning of the first gray scale wheel (211) and the first color wheel (240). The comparator's insert (230) is constructed from plastic such as polypropylene and polyethylene and it can also be constructed from cardboard. The comparator's insert (230) has a length between 3.5 and 5.0 inches, preferably 4.0 inches, width between 3.5 and 5.0 inches, preferably 4.0 inches and thickness of 15.0 and 40.0 mils, preferably 20.0 mils. The comparator's insert (230) is attached to the top. comparator body (210) and the bottom comparator body (250) with adhesive, double-sided adhesive tape or riveted or screwed. The first color scale wheel (240) is constructed from transparent or opaque plastic such as polyester or polystyrene having a diameter between 3 inches and 5 inches, preferably 3.6 inches and thickness between 5 mils and 15 mils, preferably 10 mils. The first color scale wheel (240) has a color scale that match the colors produced on the surface wipe (100) upon swiping target surface contaminated with different quantities or concentrations of target substance. The color scale can be step increments of color as shown in FIG. 13A or gradual smooth increments as shown in FIG. 13B. The first color scale wheel (240) has an opening in the middle, the first color scale wheel rivet opening (241), coaxial with and under the rivet first opening (211) and the first gray scale wheel rivet opening (221).

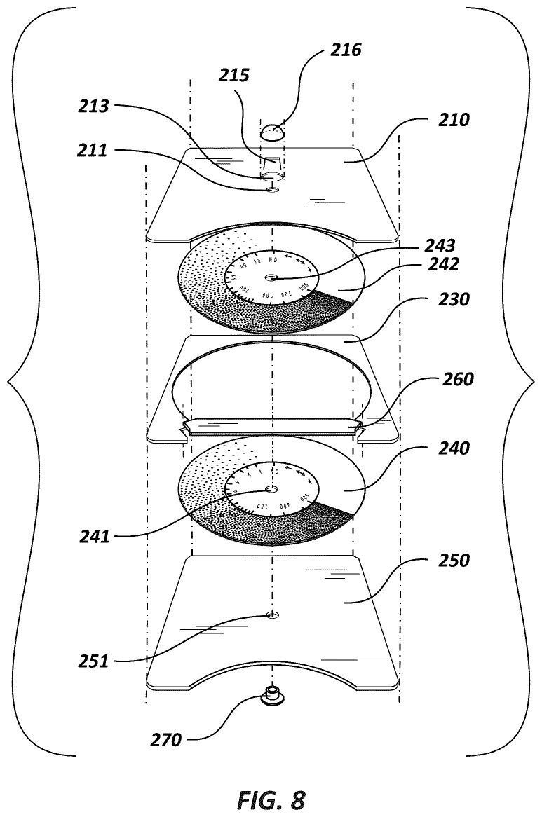

FIG. 8 is an exploded view of another embodiment of the color comparator (200) depicted in FIG. 1 where two color wheels are depicted coaxial on top of each other to increase the concentrations span of the color comparator. For example, the second color wheel (242) has color scale calibrated to measure concentrations from 1 mg to 100 mg and the first color wheel (240) has scale calibrated to measure concentrations from 100 mg to 1000 mg. Hence, in this embodiment, the color comparator is capable of measuring concentrations from 1 mg to 1000 mg. In operation, user place the swiped wipe (100) upside down on the color comparator, as shown in FIG. 10 and then turns the first color wheel (240) until ND (not detected) appears on the lower half of the first number window (213), then turning the second color window (242) until color match appears on the color scale window (215). If the color on the surface wipe is darker than the darkest color on the second color wheel (242), the second color wheel is turned until (ND) appears on the top half of the first number window (213) and the first color wheel (240) is turned until color match appears.

The color wheel (240) has color scale designated to specific concentrations of the target substance. The color wheel can be transparent or opaque. The gray scale wheel (220) is transparent wheel located on top of the color wheel (240) and has arbitrary gray scale to enhance the color matching process and it has no effect in determining the quantity or concentration of the harmful substance collected on the wipe.

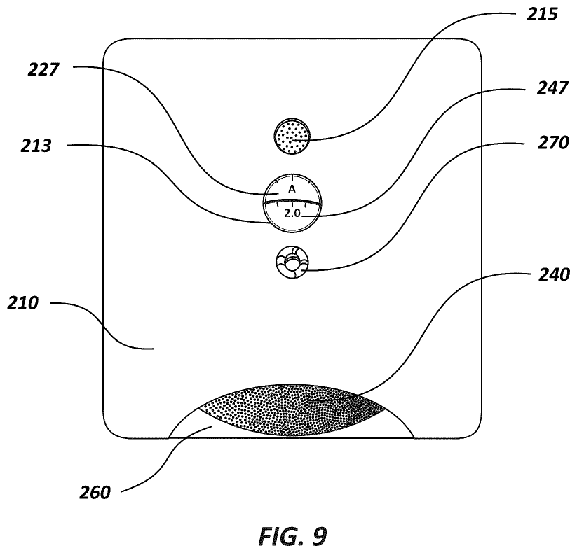

FIG. 9 is top view of one embodiment of the color comparator (200) depicted in FIG. 1 and FIG. 7.

FIG. 10 is a schematic drawing of one embodiment of the surface wipe (100) and color comparator (200) in use to determine the amount of substance collected on the surface wipe. In this embodiment, the protective sleeve (280) is inserted into the left side of the color comparator (200) and the swiped surface wipe is placed on top of the protective sleeve (280) with the swiping surface (142) facing up and next to the color scale window (215). The protective sleeve (280) functions to protect the color comparator (200) from contamination of toxic substance that might be collected on the surface wipe (100). The protective sleeve is disposable, preferably constructed from transparent plastic such as polyethylene or polypropylene, but it can be constructed from any flexible nonporous substance that satisfies its intended use.

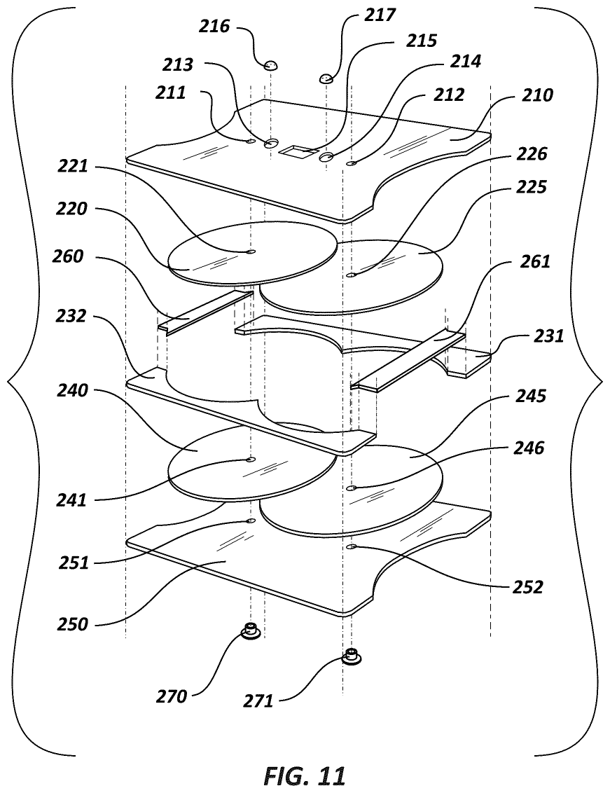

FIG. 11 is an exploded view of another embodiment of the color comparator (200) where one set of color wheels (240) and (245) and one set of gray scale wheels (220) and (225) are included to increase the span measurement of the comparator or to determine the concentrations of two different contaminants. The first color wheel (240) is located under and coaxial with the first gray scale wheel (220). The first color wheel (240) and the first gray scale wheel (220) are separated by the first separator (260) for smooth movement of the wheels. The third color wheel (245) is located under and coaxial with the second gray scale wheel (225). The third color wheel (245) and the second gray scale wheel (225) are separated by the second separator (261) for smooth movement of the wheels. The first rivet (270) is inserted into the rivet first bottom opening (251) passing through the coaxial first color wheel rivet opening (241) and the first gray scale wheel rivet opening (221) and riveted to the comparator body (210) at the rivet first top opening (211). Similarly, the second rivet (271) is inserted into the rivet second bottom opening (252) passing through the coaxial third color wheel rivet opening (246) and the second gray scale wheel rivet opening (226) and riveted to the comparator body (210) at the rivet second top opening (212). In this embodiment the color comparator can be designed to determine the concentration of one contaminant, the first color wheel (240) is calibrated to measure concentrations between 1 mg and 1000 mg, and the third color wheel (245) is calibrated to measure concentrations between 1,000 mg and 10,000 mg. In operation the swiped surface wipe (100) is placed upside down with the wiping member (142) facing up next to the color scale window (215). The third color wheel (245) is rotated until the letter ND appears in the second numbers window (214) and the second gray scale wheel (225) is rotated until the number zero (0) appears in the second numbers window (214). The first color wheel (240) and the first gray scale wheel (220) are rotated until a color match appears in the color scale window (215). If the color on the wiping member (142) is darker than the darkest color on the first color wheel 240), then the first color wheel (240) is rotated until the letter ND appears in the first numbers window (213) and the first gray scale wheel (220) is rotated until the number zero (0) appears in the first numbers window (213). The third color wheel (245) and the second gray scale wheel (225) are then rotated until a color match appears in the color scale window (215). In yet another alternative embodiment of the color comparator, the two gray scale wheels are replaced with two color wheels. The four-color wheels can be designed to measure one contaminant for wide range of measuring the concentration of one contaminant, or each pair of coaxial color wheels measuring different contaminant, in this case the comparator capable of measuring two different contaminants. Or each of the four-color wheels are designed to measure different contaminants, in this case the comparator is capable of measuring the concentration of four different contaminants.

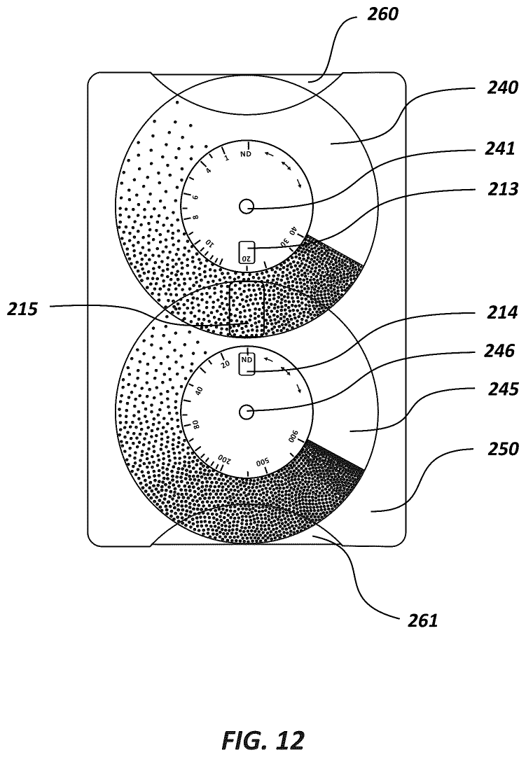

FIG. 12 is a top view of two-color wheels (240) and (245). The two-color wheels can be designed to measure one contaminant for expand range of measurement, or the two wheels can be designed to measure two different contaminants.

FIG. 13A is a top view of the first color wheel (240) where the color scale is gradually and smoothly increases. The first and second gray scale wheels (220) and (225) can also be designed with gradual and smooth gray scales.

FIG. 13B is a top view of the first gray scale wheel (220) where the gray scale is gradual step increments. The first, second and third color wheels (240), (242) and (245) can also be designed with gradual step increments scales.

The handle described in the Chem wipe operating instructions is constructed from 10 mill half circle plastic attached to the top support 120 with one clear one sided adhesive circle. This construction leads to frequent detachment of the handle from the top support and the wipe during the swiping process by the user.

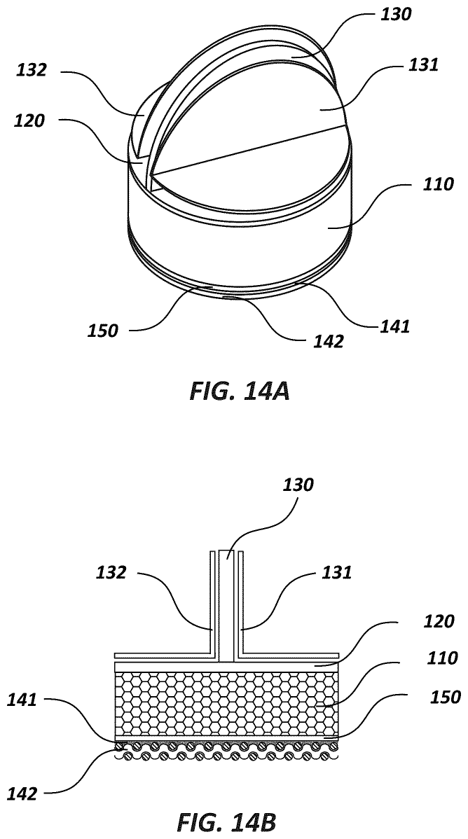

In the current device of the claimed invention as shown in FIGS. 14A and 14B, the handle is constructed from a 15 mill half circle plastic member attached to the top support 120 with two clear one-sided adhesive circles 131 and 132; each adhesive circle is provided on opposite sides of the half circle handle. One half of each adhesive circle 131 and 132 is folded along a central axis to cause a semicircular portion of each adhesive circle that is substantially one-half thereof to adhere to the top support and the other one-half of the semicircular portion to adhere to the handle 130. This construction secures the handle 130 to the top support no matter how hard the user swipes the surface.

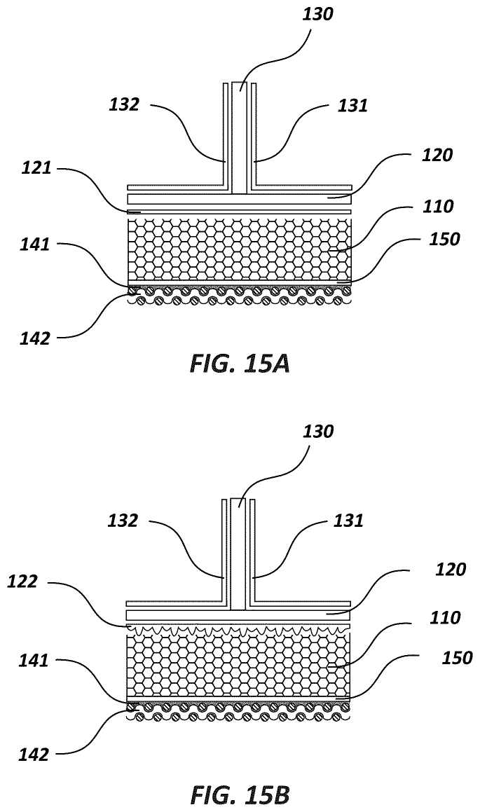

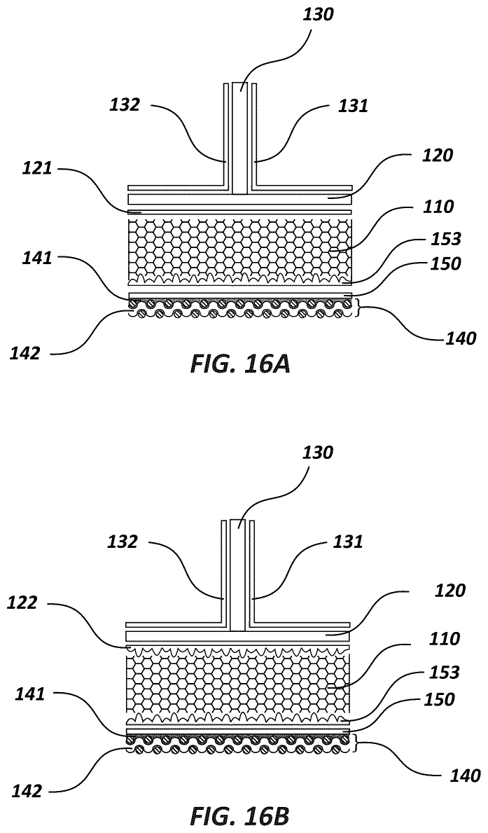

FIGS. 15 and 16 show the current device, wherein the top support 120 is glued to the wipe body 110 with liquid adhesive 122 and 153. The liquid adhesive penetrates the top of the textured body and permanently attaches the top support to the wipe body no matter how hard the user swipes the surface.

When double-sided adhesive was used, off gas materials led to shortening the shelf life of the device. Contrary to the liquid adhesive in the currently claimed device, it does not generate off-gas harmful substances and hence extends the shelf life of the device.

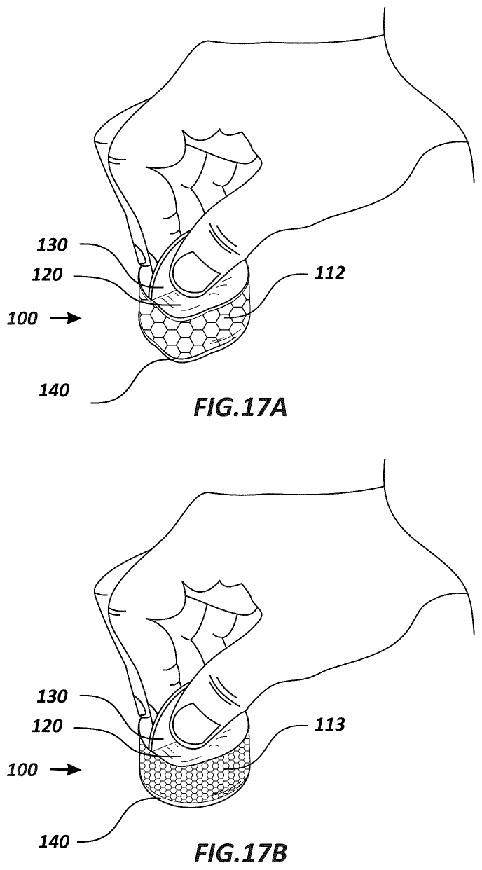

FIG. 17A shows how the pressure applied by fingers on the low-density wipe body foam during wiping causes deformation of the wiping and color forming assembly 140 that leads to irregular color formation and inaccurate results. FIG. 17B shows how the high-density wipe body foam absorbs the pressure applied by fingers without deforming the wiping and color forming assembly 140 leading to uniform color formation and accurate results. The flexible surface wipe body in the currently claimed device is constructed from higher density foam (6 LB) that is capable of fully absorbing the pressure caused by the user fingers no matter how hard the user pressed the wipe during swiping. This change led to uniform color formation and accurate determination of the amount of the collected target substance.

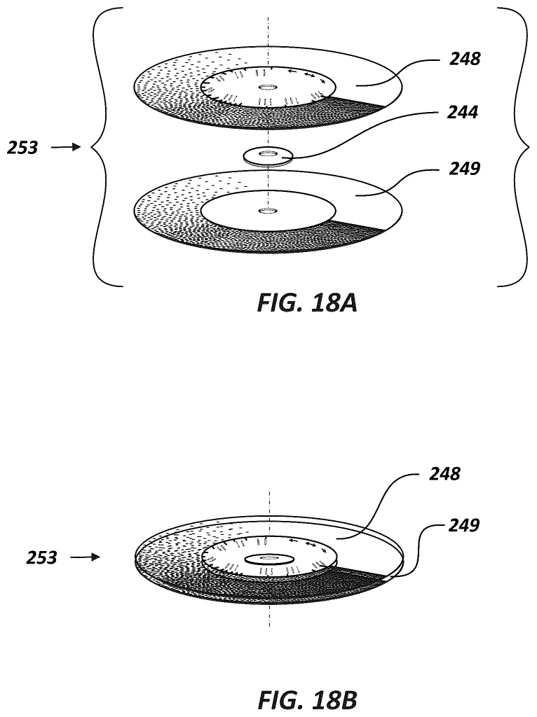

When dealing with high concentrations of contaminants, dark colors are produced. It was impossible to print these dark colors on clear plastic. In the current device of FIG. 18, two color wheels are arranged coaxial to each other. The top color wheel 248 with numbers is attached with liquid adhesive 244 to the bottom color wheel without numbers 249 to produce a color wheel assembly with dark colors 253 suitable for quantifying high concentration contaminants accurately. The collection surface of the previous embodiment was constructed from porous 70% opaque material. This led to significant masking of the color formed. In the current device, the collection surface is constructed from porous 35% opaque material.

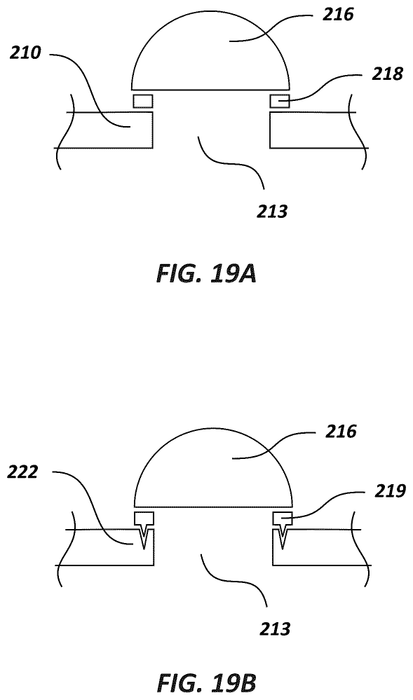

In the previous embodiment, the magnifying lens 216 was glued with liquid adhesive to the numbers window 113 in the top comparator body 210, as shown in FIG. 19A. This construction leads to easy detachment of the magnifying lens from the top comparator body 210. In an improved embodiment of the current device, the edge of the numbers window 113 is perforated, such that when the liquid adhesive 219 applied, it penetrates the perforation in the top comparator body 222. When dried, the adhesive 219 forms anchors that hold the magnifying lens 216 permanently to the top comparator body, as shown in FIG. 19B.

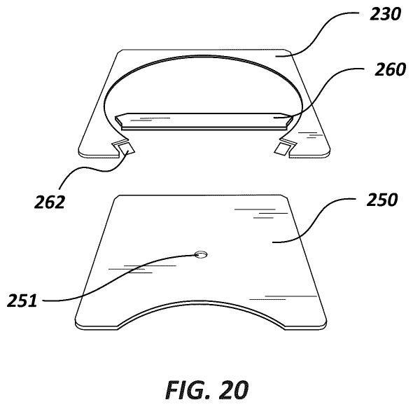

In a previous embodiment, the separator 260 was placed between the color wheels which led to the separator falling from the comparator during use in some cases. In the current construction of FIG. 20, the separator is glued with double sided adhesive 262 from both sides to the bottom comparator body 250. This construction permanently attaches the separator to the comparator and assures that the separator will not fall from the comparator during use.

Several embodiments of the present invention have been described herein. It should be understood by those of ordinary skill in the art, however, that the above described embodiments, are set forth merely by way of example and should not be interpreted as limiting the scope of the invention. Other alternative embodiments, variations and modifications of the foregoing embodiments that embrace various aspects of the present invention will also be understood upon reading of the detailed description in light of the prior art.

1-15 (canceled)

16. A detection system for the quantification of at least one target substance on a target surface comprising:
a surface wipe (100) which is held by a user and swiped across a surface for the detection and quantification of at least one target substance on said target surface by forming a visual and uniform color change indicative of the presence and amount of the at least one target substance, said surface wipe comprising:
a handle (130) which is held during swiping of the target surface with the surface wipe (100), said handle having a first side and a second side;
a flexible surface wipe body (110) that conforms to the physical profile of the target surface to spread any pressure applied onto the surface wipe throughout its mass during swiping of the surface to ensure uniform color change indicative of the presence of the at least one target substance and the amount thereof on the target surface;
a top support (120) attaching said handle (130) to the surface wipe body (110), said top support having an upper surface;
a first circular adhesive member having a first side comprising adhesive and a second side without adhesive, said first circular adhesive member folded in the center at substantially ninety degrees to create a pair of semicircular portions such that the adhesive of the first side adheres to both the first side of the handle and the upper surface of the top support;
a second circular adhesive member having a first side comprising adhesive and a second side without adhesive, said second circular adhesive member folded in the center at substantially ninety degrees to create a pair of semicircular portions such that the adhesive of the first side adheres to both the second side of the handle and the upper surface of the top support;
a wiping and color forming assembly (140) that collects and reacts with the target substance to form an accurate color change indicative of the amount of the target substance present on the target surface;
a bottom support (150) arranged between said surface wipe body (110) and said wiping and color forming assembly (140) and attaching the surface wipe body (110) to the color forming assembly (140); and, a color comparator (200) including a plurality of predetermined color scales representing a range of masses or concentrations values of the target substance detected upon the target surface.

17. The detection system of claim 16 wherein concentrations values of the target substance on the target surface are expressed in numbers on the color comparator which further includes an arbitrary gray scale to enhance a color matching process between a color displayed on the color forming assembly and said color comparator.

18. The detection system of claim 16 wherein said color comparator further comprises:
a top comparator body (210) having one color scale window (215), at least one numbers window and at least one rivet opening;
a bottom comparator body (250) having at least one rivet opening;
at least one color scale wheel having a predetermined color scale representing a range of masses or concentrations values of the target substance expressed in numbers, said color wheel having one rivet opening;
at least one gray scale wheel having arbitrary values expressed in alphabets to enhance the color matching process, said gray scale wheel having one rivet opening;
at least one comparator inserts which function to separate said top comparator body (210) from said bottom comparator body (250) to allow free movement between said color wheel and said gray scale wheel;
at least one separator having a smooth surface arranged between the at least one color scale wheel and said gray scale wheel;
at least one magnifying lens;
at least one rivet arranged within the rivet opening of the top comparator body (210), bottom comparator body (250), the at least one color scale wheel, and the at least one gray scale wheel together to allow free rotation of said color scale wheel and said gray scale wheel; and,
a disposable protective sleeve which functions to protect said color comparator from contamination during use.

19. The detection system of claim 16 further comprising:
a cavity formed in the surface wipe body (110) for depositing a crushable ampoule therein; and,
a glass crushable ampoule (160) filled with reagent, said glass crushable ampoule (160) arranged within the cavity formed in the surface wipe body (110).

20. The detection system of claim 16 wherein the surface wipe (100) comprises a handle (130) formed from a plastic attached or glued on top of said top support (120).

21. The detection system of claim 16 wherein the top support (120) is constructed from one of flexible and rigid material, said top support (120) attaches or is glued on a top side to said handle (130) and attaches or is glued on a bottom side to said surface wipe body (110).

22. The detection system of claim 16 wherein said surface wipe body (110) comprises one of a flexible closed-pores and an open-pores material.

23. The detection system of claim 16 wherein said bottom support (150) is constructed from one of a flexible and a rigid material and attaches or is glued on a top surface of the bottom support (150) to said surface wipe body (110) and attaches or is glued from on a bottom surface to said color forming assembly (140).

24. The detection system of claim 16 wherein said wiping and color forming assembly (140) consists of a color forming member (141) coated on a top surface of the collection member (142).

25. The detection system of claim 24 wherein in said collection member (142) is formed from an inert, open-pores and flexible material.

26. The detection system of claim 16 wherein the color comparator (200) comprises a gray scale wheel arranged under and coaxial with said top comparator body (210), and on top of and coaxial with said color scale wheel.

27. The detection system of claim 16 wherein the color comparator (200) comprises a color scale wheel arranged under and coaxial with said gray scale wheel, and on top and coaxial with said bottom comparator body (250).

28. The detection system of claim 16 wherein the color comparator (200) comprises an insert attached on a bottom surface to said top comparator body (210) and attached on a top surface to said bottom comparator body (250).

29. The detection system of claim 16 wherein the comparator (200) comprises said rivet arranged coaxial within said top comparator body rivet opening, said bottom comparator rivet opening, said gray scale wheel rivet opening and said color scale wheel rivet opening.

30. The detection system of claim 16 wherein said comparator (200) comprises said color scale wheel formed from at least one of transparent, opaque, rigid, and flexible plastic.

31. The detection system of claim 16 wherein said comparator (200) comprises a gray scale wheel is formed from at least one of transparent, rigid and flexible plastic.

32. A method for providing qualitative and quantitative determination of a preselected substance on surfaces comprising:
(i) swiping the surface with the surface wipe (100) over a predetermined sized area;
(ii) forming a color on the color forming assembly (140);
(iii) inserting a protective sleeve (280) onto the color comparator (200);
(iv) placing the swiped surface wipe (100) upside down on top of the protective sleeve (280) and the color comparator (200) next to the color scale window (215);
(v) adjusting the color wheel (240) until the color on the color forming assembly (140) matches one of the predetermined colors on the color wheel (240);
(vi) adjusting the arbitrary gray scale wheel (220) until a better color match is obtained;
(vii) matching the color to identify a target substance; and, (viii) viewing the number displayed within the numbers window (213) to quantify the target substance.

33. The detection system of claim 16 wherein said flexible surface wipe body comprises 6 lb foam.

34. The detection system of claim 16 wherein a color comparator (200) includes a top color wheel 248 with numbers attached with liquid adhesive 244 to the bottom color wheel without numbers 249 to produce a color wheel assembly with dark colors 253 suitable for quantifying high concentration contaminants accurately.

35. The detection system of claim 16 wherein a collection surface of wiping and color forming assembly (140) comprises a porous 35% opaque material.
